(19) United States
(12) Patent Application Publication
(10) Pub. No.: US 2026/0113610 A1
(43) Pub. Date: Apr. 23, 2026

(54) IDENTIFYING PACKET CORE NETWORK FUNCTIONS RESPONSIBLE FOR EMERGENCY CALL FAILURES

(71) Applicant: T-MOBILE INNOVATIONS LLC, Overland Park, KS (US)

(72) Inventors: Maria Victoria Cabamalan, Covington City, WA (US); Erwin Ducusin Sapuay, Lodi, NJ (US); Joseph Amagna Santor, Renton, WA (US); Jonathan Sarbillon Ramirez, Little Elm, TX (US); June Allan Malit, Renton, WA (US); John Barry Santiago Lazarte, Tukwila, WA (US)

(21) Appl. No.: 18/922,792

(22) Filed: Oct. 22, 2024

(51) Int. Cl. H04W 4/90; H04L 65/1104

(52) U.S. Cl. CPC H04W 4/90; H04L 65/1104

(57) ABSTRACT

Systems, methods, and devices are disclosed for reducing the number of emergency call failures in wireless communication networks. More specifically, the present technology includes systems and methods for detecting emergency call failures and identifying packet core network functions (NFs) causing failures in near real-time. A method of operating a wireless communication network includes monitoring data associated with one or more emergency call functions to detect abnormalities in the data indicative of emergency call failures; in response to detecting an abnormality in the data, processing other data associated with one or more other network functions to determine whether one or more corresponding abnormalities are present in the other data; and, in response to determining that at least one corresponding abnormality is present in the other data, generating an alert to indicate that the abnormality exists. The method may be performed, at least in part, by one or more machine learning models.

### TECHNICAL FIELD

Various embodiments of the present technology relate to wireless communication networks and in particular to accurately detecting and mitigating the effects of emergency call failures.

### BACKGROUND

In modern wireless communication networks (e.g., 5G standalone networks), ensuring the reliability of emergency calls is a critical challenge, particularly due to the complexity of the network infrastructure. Unlike regular voice or data calls, emergency calls must traverse specific network paths and often rely on specialized nodes within the packet core, such as the Emergency Services Mobile Location Center (ESMLC), Gateway Mobile Location Center (GMLC), and Network Management Function (NMF). These specialized nodes, which are not used for routine communication services, add complexity to identifying and addressing the root causes of emergency call failures. With emergency call volumes significantly lower than that of regular calls, it becomes difficult to proactively monitor these nodes and detect potential failures.

A further complication is the segmentation of control and user plane traffic within network nodes (e.g., 5G core nodes). Key network functions, such as the Access and Mobility Function (AMF) and Session Management Function (SMF), are primarily responsible for control plane activities and lack visibility into user plane traffic. This division limits their ability to fully diagnose whether an emergency call has failed, as they cannot directly monitor the flow of user data. Moreover, emergency call failures can often be triggered by events such as network changes, software updates, or configuration changes within these nodes, inadvertently impacting emergency services in ways that do not affect regular calls.

With hundreds or even thousands of packet core nodes to monitor, and each handling complex processes, it becomes difficult to pinpoint which node is responsible for an emergency call failure or which Key Performance Indicators (KPIs) to watch. The importance of rapid detection and mitigation of emergency call failures is of great importance, however, as the inability to complete an emergency call can be life-threatening and missed emergency communications could result in critical delays in life-saving services. An improved system for detecting and correcting emergency call issues is therefore essential for the safe and reliable operation of communication networks.

It is with respect to this general technical environment that aspects of the present technology disclosed herein have been contemplated. Furthermore, although a general environment has been discussed, it should be understood that the examples described herein should not be limited to the general environment identified in the background.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments of the present technology generally relate to improving the user experience in wireless communication networks. More specifically, the technology disclosed herein includes systems and methods for quickly detecting network functions causing emergency call failures in wireless communication networks. In a first embodiment, a method of operating a wireless communication network includes monitoring data associated with one or more emergency call functions to detect abnormalities in the data indicative of emergency call failures. The method further includes, in response to detecting an abnormality in the data, processing other data associated with one or more other network functions to determine whether one or more corresponding abnormalities are present in the other data and, in response to determining that a corresponding abnormality is present in the other data, generating an alert to indicate that the corresponding abnormality exists.

In some embodiments, the data associated with the one or more emergency call functions indicative of the emergency call failures includes at least one of session initiation protocol (SIP) invite data from the one or more emergency call functions and location services data from the one or more emergency call functions. The one or more emergency call functions, in some embodiments, includes at least one of a proxy call session control function (P-CSCF) and a gateway mobile location center (GMLC). In an embodiment, the abnormality in the data corresponds to a timestamp and the corresponding abnormality also corresponds to the timestamp. In some embodiments, the other data associated with the one or more other network functions includes at least one of service request data, packet data unit (PDU) establishment data, session resource modification data, location event notify data, provide location data, and PDU session management create context data. The one or more other network functions may include an access and mobility management function (AMF) and a session management function (SMF). Monitoring the data to detect the abnormalities may include providing the data as input to at least one machine learning model trained to detect the abnormalities. Similarly, processing the other data associated with the one or more other network functions may include providing the other data as input to the at least one machine learning model. The machine learning model, in some cases, includes a kernel density estimation model.

In an alternative embodiment, one or more non-transitory computer-readable storage media have program instructions stored thereon that, when executed by a computing system, direct the computing system to perform certain operations. The operations include monitoring data associated with one or more emergency call functions to detect abnormalities in the data indicative of emergency call failures. The operations further include, in response to detecting an abnormality in the data, processing other data associated with one or more other network functions to determine whether one or more corresponding abnormalities are present in the other data and, in response to determining that a corresponding abnormality is present in the other data, generating an alert to indicate that the corresponding abnormality exists.

In yet another embodiment, a system includes one or more computer-readable storage media, a processing system operatively coupled with the one or more computer-readable storage media, and program instructions stored on the one or more computer-readable storage media. The program instructions, when read and executed by the processing system, direct the processing system to at least monitor data associated with one or more emergency call functions to detect abnormalities in the data indicative of emergency call failures. The program instructions further direct the processing system to, in response to detecting an abnormality in the data, process other data associated with one or more other network functions to determine whether one or more corresponding abnormalities are present in the other data and, in response to determining that a corresponding abnormality is present in the other data, generate an alert to indicate that the corresponding abnormality exists.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an overview of anomaly detection in a wireless communication network to in accordance with some embodiments of the present technology;

FIG. 2 is a first flowchart illustrating a series of steps performed in a wireless communication network in accordance with some embodiments of the present technology;

FIG. 3 is a second flowchart illustrating a series of steps performed in a wireless communication network in accordance with some embodiments of the present technology;

FIG. 4 illustrates KPIs that may be collected from emergency call-related nodes in a wireless communication network in accordance with some embodiments of the present technology;

FIG. 5 illustrates a 5G standalone architecture in which embodiments of the present technology may be implemented; and

FIG. 6 illustrates a computing system suitable for implementing the various operational environments, architectures, processes, scenarios, and sequences discussed below with respect to the other Figures.

### DETAILED DESCRIPTION

Systems, methods, and devices are disclosed herein for reducing the number of emergency call failures in wireless communication networks (e.g., 4G and 5G communication networks). More specifically, the present technology includes systems and methods for detecting emergency call failures and identifying packet core network functions (NFs) causing the failures in real-time or near real-time.

The ability to detect emergency call failures and promptly address the issue at the correct network node is critical for supporting public safety, as failure to complete an emergency call can have potentially life-threatening consequences. In urgent situations, timely access to emergency services is essential, and any disruption or delay in the call process could result in critical delays in life-saving assistance.

Unlike routine communications, emergency calls utilize specialized network nodes, making the identification and resolution of failures more complex, in part due to the much smaller call volume compared to other call procedures going through the packet core network. Further complications arise from the segmented nature of control and user plane traffic within network nodes. Key NFs, such as the Access and Mobility Function (AMF) and the Session Management Function (SMF), are primarily responsible for control plane activities and lack visibility into user plane traffic. This division limits their ability to fully diagnose whether an emergency call has failed, as they cannot directly monitor the flow of user data. Failure-causing issues may be induced by network updates, software upgrades, configuration updates, or other events that can inadvertently impact emergency call functionality. Consequently, the ability to rapidly detect and resolve emergency call failures is of paramount importance to ensure the reliability and accessibility of emergency services when they are most needed.

Thus, the technology disclosed herein leverages specific data (i.e., KPIs) collected at emergency-specific nodes (e.g., GMLC and LRF) as well as shared nodes (e.g., AMF and SMF) to detect when emergency call failure rates have increased and identify the specific node(s) responsible for the failures. By correlating key parts of the end-to-end emergency call establishment KPIs and call completion call flow using machine learning, the present technology drastically improves mean-time-to-detect (MTTD) and mean-time-to-resolve (MTTR) for emergency call failures.

Various technical effects may be appreciated from the implementations disclosed herein. Such technical effects that result from improved detection and mitigation of emergency call failures include increased network reliability, reduced response time for issue resolution, and improved accuracy in root cause analysis. Additionally, the technology disclosed herein replaces traditionally-used static thresholds with adaptive monitoring that allows anomaly detection in real-time or near-real-time. The present technology further results in enhanced scalability and management of large networks, minimized service disruptions during network upgrades, improved quality of service (QoS) for emergency services, improved compliance with regulatory standards, and optimized resource utilization, further resulting in the more efficient allocation of network resources such as bandwidth, compute power, and monitoring tools.

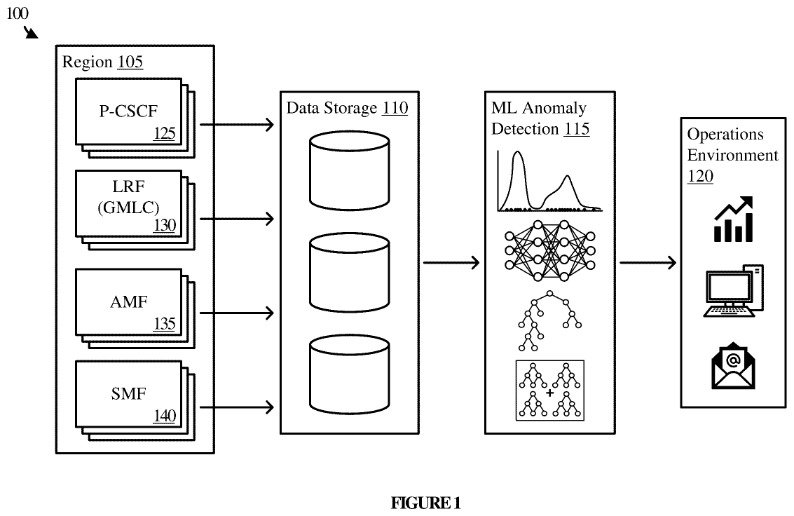

FIG. 1 illustrates anomaly detection environment 100, which is representative of some of the relevant components of a wireless communication network for detecting emergency call failures and identifying responsible network functions. Anomaly detection environment 100 includes region 105, data storage 110, ML anomaly detection module 115, and operations environment 120. Region 105 includes Proxy-Call Session Control Function (P-CSCF) 125, Location Retrieval Function (LRF) 130, which may be integrated within the Gateway Mobile Location Center (GMLC), Access and Mobility Management Function (AMF) 135, and Session Management Function (SMF) 140. The components shown in FIG. 1 are merely for purposes of example, and anomaly detection environment 100 may include additional or different elements than those illustrated in FIG. 1.

P-CSCF 125, LRF 130, AMF 135, and SMF 140 are representative of packet core nodes in anomaly detection environment 100. A packet core node is an element within the core network of cellular communication systems, such as 4G LTE, 5G, or other variations of networks, that processes and manages data traffic for user devices. These nodes may be responsible for functions such as user authentication, mobility management, data routing, session management, and policy enforcement. The packet core nodes are part of the overall packet core network architecture, which provides IP-based services such as internet access, voice calls, and various other data services.

P-CSCF 125 is responsible for session initiation protocol (SIP) signaling, session control, and managing multimedia sessions (including emergency calls) between user equipment and the IP Multimedia Subsystem (IMS) core. LRF 130, which may be integrated within the GMLC, is responsible for retrieving and providing accurate location information for users, particularly during emergency calls, by interacting with the core network and radio access network (RAN). The AMF handles control plane tasks, including user authentication, registration, and mobility management, ensuring seamless access to the network as users move between cells. The SMF manages the establishment, modification, and release of data sessions, handling tasks such as IP address allocation and routing user data through the network to maintain connectivity and service quality.

Region 105 is representative of a geographic area covered by the wireless network. Region 105 may vary in size depending on the specific implementation. Regions within the network may be divided based on factors such as population density, traffic load, and geographic considerations, ensuring that users in each region are served efficiently. Each region, such as region 105, contains at least one set of core nodes that handle the network functions, but many regions include multiple nodes of each type (e.g., three AMFs) to accommodate traffic volumes, load balance, sub-regions, and to ensure network reliability in the case of node failures. Regions are interconnected via the core network. As shown in FIG. 1, region 105 contains multiple of each type of node shown. Thus, in addition to P-CSCF 125, region 105 contains additional P-CSCF nodes. Similarly, in addition to LRF 130, AMF 135, and SMF 140, region 105 contains additional LRF, AMF, and SMF nodes

Each of P-CSCF 125, LRF 130, AMF 135, and SMF 140 collect key performance indicators (KPIs), which are then stored in data storage 110. KPIs are metrics used to evaluate the performance, health, and efficiency of network functions. These metrics can include data on factors such as latency, packet loss, throughput, connection success rates, call drop rates, and more. KPIs are collected from different network functions (e.g., AMF, SMF, UPF, etc.) to monitor how the network is performing in real time (or near real time) and identify potential issues. KPIs may be gathered through network monitoring systems and stored in centralized databases, such as Network Data Analytics Function (NWDAF) and/or Operations Support system (OSS).

In the present example, KPIs related to emergency call failures are collected on P-CSCF 125, LRF 130, AMF 135, and SMF 140. The KPIs related to emergency call failures collected by P-CSCF 125, LRF 130, AMF 135, and SMF 140 include but are not limited to: P-CSCF SIP Invite (URN: sos), GMLC LCS Location, AMF Service Request (emergency), AMF PDU Establishment (emergency), AMF PDU Session Resource Mod, SMF PDU Session SM Create Context (emergency), AMF Location Event Notify, and AMF Provide Location.

In the present example, these KPIs are provided as input to ML anomaly detection module 115. ML anomaly detection module 115 is an unsupervised machine learning-based anomaly detection module that is trained to detect anomalies indicating abnormal emergency call failure rates based on the KPIs listed above as well as correlate the anomalies with a specific node causing the failures. In operation, ML anomaly detection module 115 detects an abnormal increase in error in the P-CSCF SIP Invite (URN: sos) KPI and/or GMLC LCS Location KPI from P-CSCF 125 and LRF 130. Upon detecting the abnormal increase, ML anomaly detection module 115 further uses the AMF Service Request (emergency), AMF PDU Establishment (emergency), AMF PDU Session Resource Mod, SMF PDU Session SM Create Context (emergency), AMF Location Event Notify, and AMF Provide Location KPIs from AMF 135 and SMF 140 to correlate the anomaly with a specific node.

In some examples, ML anomaly detection module 115 implements a Kernel Density Estimate (KDE) machine learning algorithm to perform some or all of its detection and correlation functionality. A KDE algorithm, such as the one used in ML anomaly detection module 115, is an unsupervised, non-parametric machine learning technique for estimating the probability density function of a dataset without relying on predefined labels. For anomaly detection, such as detecting the anomalies associated with emergency call failures as discussed herein, the algorithm models the underlying distribution of data by placing a kernel (e.g., a Gaussian function) around each data point in a multi-dimensional space. By summing these kernels, a smooth, continuous estimate of the data's density is created. The model then identifies regions of higher and lower density, allowing it to determine the typical bounds of normal data behavior. Data points that fall in areas of significantly low density (i.e., outside the high-density regions where most of the data is concentrated) are classified as anomalies. Thus, the KDE algorithm can effectively detect deviations from normal patterns for purposes of network monitoring and failure detection. However, other types of machine learning models, including but not limited to neural networks, linear regression models, decision trees, support vector machines, k-nearest neighbors, naïve bayes, and the like may be used to perform the failure detection and correlation functionality described herein.

If an anomaly is detected that corresponds to the P-CSCF SIP Invite (URN: sos) KPI or GMLC LCS Location KPI anomaly, an alert may be sent indicating that there is degradation and which node is causing the degradation (i.e., which KPI is degraded). For example, “SIP 503” messages indicate that the server or network handling a call is unavailable, preventing the call from reaching its destination. Thus, if ML anomaly detection module 115 detects that the SIP 503 rate for SOS started to increase at time 1:30 p.m. in P-CSCF 125 (region 105), ML anomaly detection module 115 checks the AMF Service Request (emergency), AMF PDU Establishment (emergency), AMF PDU Session Resource Mod, SMF PDU Session SM Create Context (emergency), AMF Location Event Notify, and AMF Provide Location KPIs from all AMFs and SMFs in the region (including AMF 135 and SMF 140) at the same timestamp (i.e., 1:30 p.m.). If ML anomaly detection module 115 then detects an anomaly in one of these KPIs from one of the AMFs or SMFs (e.g., from AMF 135), an alert is sent indicating that there is degradation on SIP 503 caused by the correlated node (e.g., AMF 135).

When a node in the network is experiencing issues causing emergency call failures, various alerts may be sent, such as to an operations team, to ensure the issue is fixed. Alerts may include email notifications containing information about the node, failure type, and affected services. A real-time dashboard alert could visually indicate the problem, highlighting the affected node and displaying relevant metrics such as failure rates, KPIs, and impacted areas. On-screen notifications or pop-ups on network monitoring systems can provide immediate alerts, while automated SMS or mobile app notifications may be used for urgent, out-of-hours escalation.

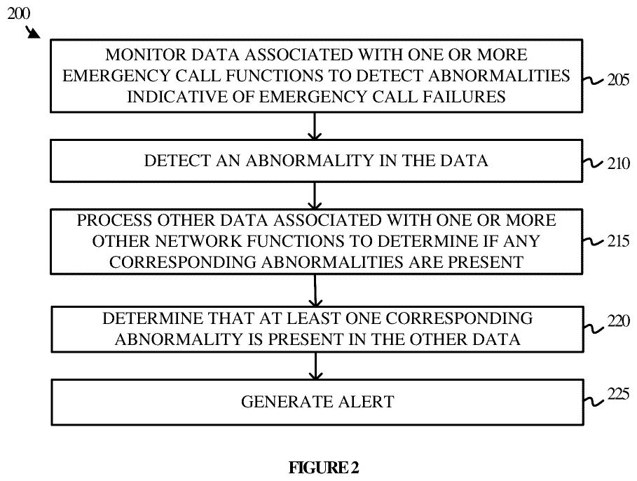

FIG. 2 illustrates process 200. Process 200 is an exemplary operation of detecting and correlating emergency call failures in anomaly detection environment 100. The operations may vary in other examples. The operations of process 200, in some examples, are performed by one or more computing elements of a wireless communication network.

The operations of process 200 include monitoring data from one or more emergency call functions to detect abnormalities indicative of emergency call failures (step 205). In the example of FIG. 1, data (i.e., the KPI values) is collected from at least P-CSCF 125, LRF 130, AMF 135, and SMF 140 in region 105, stored in data storage 110, and monitored by ML anomaly detection module 115. The KPI “P-CSCF SIP Invite (URN: sos)” is collected from P-CSCF 125. The KPI “GMLC LCS Location” is collected from LRF 130. The KPIs “AMF Service Request (emergency),” “AMF PDU Establishment (emergency),” “AMF PDU Session Resource Mod,” “AMF Location Event Notify,” and “AMF Provide Location are collected from AMF 135.” The KPI “SMF PDU Session SM Create Context (emergency)” is collected from SMF 140. The data monitored in step 205 includes the data corresponding to emergency calls collected from P-CSCF 125 and LRF 130. In some cases, the data collected from AMF 135 and SMF 140 is not monitored during step 205, but merely stored in data storage 110 until an abnormality is detected in step 210.

The operations of process 200 further include detecting an abnormality in the data (step 210). In the example of FIG. 1, ML anomaly detection module 115 detects an abnormality in the data from P-CSCF 125 and/or LRF 130 provided as input to one or more machine learning models of ML anomaly detection module 115. The one or more machine learning models, in some examples, include a KDE algorithm. The one or more machine learning models are trained to detect abnormalities in the data. Detecting the abnormality, in the example of FIG. 1, includes receiving an output from a machine learning model of ML anomaly detection module 115 indicating that the abnormality is present.

The terms “abnormality” and “anomaly,” as used herein, refer to abnormal or unexpected behavior that deviates from the typical pattern of call traffic. An abnormality refers to any deviation from what is normal, expected, or typical in a given system or process, generally encompassing a broad range of irregularities. An anomaly is type of abnormality that indicates something unusual or unexpected that stands out from normal behavior. In some examples, an anomaly is a critical abnormality that signifies an issue or fault in the communication network. For example, a sudden spike in failed SIP invite requests for emergency calls could indicate an issue with the network or node handling those requests, such as the P-CSCF. Anomalies in this KPI could signal disruptions that prevent emergency calls from being established. To detect anomalies, the anomaly detection model compares, in near real time, the current data to historical data from the same day (e.g., Wednesday) and time (e.g., 2:20 p.m.) on earlier dates.

The operations of process 200 further include processing other data from one or more other network functions to determine if any corresponding abnormalities are present (step 215). In the example of FIG. 1, if an abnormality exists in the data from the emergency call functions (e.g., the P-CSCF SIP Invite (URN: sos) KPI from P-CSCF 125 or the GMLC LCS Location KPI from LRF 130), one or more machine learning models of ML anomaly detection module 115 compare the data from the other network functions (e.g., data from AMF 135 and SMF 140) to find corresponding abnormalities that may indicate the source of the problem. To find corresponding abnormalities, the one or more machine learning models analyze data corresponding to the same or similar timestamp as the abnormality detected in step 210.

The operations of process 200 further include determining that at least one corresponding abnormality is present in the other data (step 220). Determining that at least one abnormality is present in the other data includes analyzing data from the AMF and/or SMF at the same time or at a similar time as the abnormality in the emergency call function data. In the example of FIG. 1, one or more machine learning models of ML anomaly detection module 115 provide output indicating that one or more abnormalities exist in the other data (i.e., the data from AMF 135 and/or SMF 140) at the same time or a similar time to that of the abnormality detected in the emergency call data (i.e., the data from P-CSCF 125 and/or LRF 130).

The operations of process 200 further include generating an alert to notify one or more teams of the abnormality and associated node (step 225). In the example of FIG. 1, if at least one abnormality detected by ML anomaly detection module 115 from the other data corresponds to the abnormality detected in the emergency call data, an alert may be sent to operations environment 120 indicating that there is degradation and which node is causing the degradation. Various types of alerts may be sent depending on the implementation. Alerts may include email notifications containing information about the node, failure type, and affected services. A real-time dashboard in operations environment 120 could visually indicate the problem, highlighting the affected node and displaying relevant metrics such as failure rates, KPIs, and impacted areas. On-screen notifications or pop-ups on network monitoring systems can provide immediate alerts, while automated SMS or mobile app notifications may be used for urgent, out-of-hours escalation

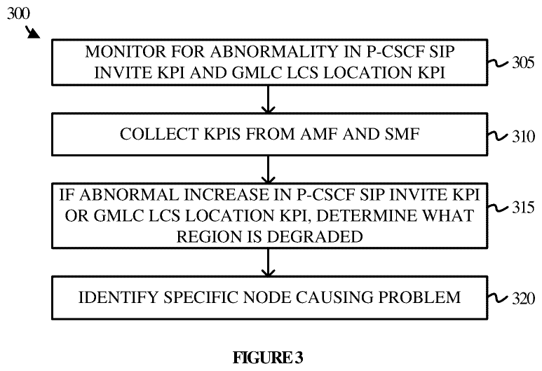

FIG. 3 illustrates process 300. Process 300 is another exemplary operation of detecting and correlating emergency call failures in anomaly detection environment 100. The operations may vary in other examples. The operations of process 300, in some examples, are performed by ML anomaly detection module 115.

The operations of process 300 include monitoring for an abnormality in the P-CSCF SIP Invite KPI and GMLC LCS Location KPI from P-CSCF and GMLC nodes (step 305). In the example of FIG. 1, ML anomaly detection module 115 monitors for abnormalities in the KPIs collected from all P-CSCFs and LRFs in various regions (including region 105) including but not limited to P-CSCF 125 and LRF 130. Monitoring the KPIs, in some examples, includes obtaining the KPI values from data storage 110, providing them as input to one or more machine learning models of ML anomaly detection module 115, and receiving output from the one or more machine learning models indicating whether anomalies are present or not.

The operations of process 300 further include collecting the AMF Service Request (emergency), AMF PDU Establishment (emergency), AMF PDU Session Resource Mod, SMF PDU Session SM Create Context (emergency), AMF Location Event Notify, and AMF Provide Location KPIs from AMF and SMF nodes (step 310). In the example of FIG. 1, ML anomaly detection module 115 obtains the KPIs collected from all AMFs and all SMFs in multiple regions (including region 105), including but not limited to AMF 135 and SMF 140, from data storage 110. In some examples, ML anomaly detection module 115 only obtains the AMF and SMF KPIs from storage once an anomaly is detected in the P-CSCF SIP Invite KPI or GMLC LCS Location KPI.

The operations of process 300 further include, if an abnormal increase in the P-CSCF SIP Invite KPI or the GMLC LCS Location KPI is detected, determining what region is degraded based on KPIs collected from the AMF and SMF (step 315). In the example of FIG. 1, ML anomaly detection module 115 detects an abnormal increase in the P-CSCF SIP Invite KPI or the GMLC LCS Location KPI at a certain timestamp. ML anomaly detection module 115 then provides the KPIs collected from the AMFs and SMFs in all regions and analyzes each of them at the same timestamp for anomalies. To determine if an anomaly is present at a given timestamp, ML anomaly detection module 115 compares the most recent KPI values to historical KPI values from the same day and time to determine if the recent KPI values are inside or outside of a normal range (e.g., within or out of a predetermined and/or historical KPI value range). For example, recent KPI values being outside of the normal range may indicate an abnormal increase.

The operations of process 300 further include identifying the specific node causing the problem (step 320). In the example of FIG. 1, ML anomaly detection module 115, after determining that an anomaly is present in one of the AMF or SMF KPIs at the timestamp, drills down into the KPI data to determine which node produced the KPI anomaly and is thus responsible for the increase in emergency call failures.

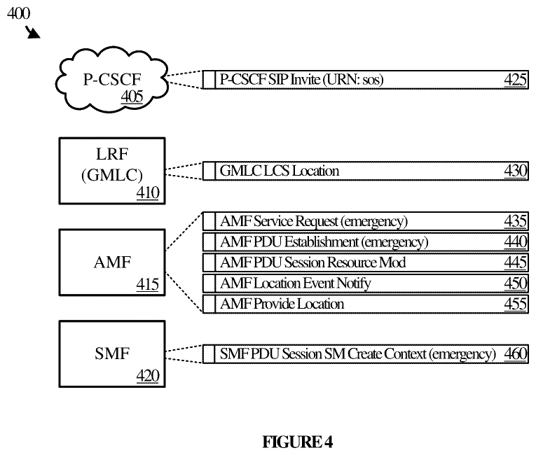

FIG. 4 illustrates KPI view 400. KPI view 400 is an example of the various network functions and respective KPIs that are monitored in accordance with embodiments of the present technology. KPI view 400 includes P-CSCF 405, LRF 410, AMF 415, and SMF 420. KPI P-CSCF SIP Invite (URN: sos) 425 is collected on P-CSCF 405. KPI GMLC LCS Location 430 is collected on LRF 410. KPIs AMF Service Request (emergency) 435, AMF PDU Establishment (emergency) 440, AMF PDU Session Resource Mod 445, AMF Location Event Notify 450, and AMF Provide Location 455 are collected on AMF 415. KPI SMF PDU Session SM Create Context (emergency) 460 is collected on SMF 420.

KPI P-CSCF SIP Invite (URN: sos) 425 monitors performance of emergency call initiations by monitoring the number and status of SIP Invite requests made to initiate emergency calls via the P-CSCF. Its values represent whether the network successfully handles these emergency call initiation requests, with any failures potentially pointing to serious issues affecting emergency services availability. Types of P-CSCF emergency SIP failures include registration failures, authentication failures, routing failures, SIP message processing errors, network interface failures, policy and charging control failures, timeouts and latency issues, resource allocation failures, security and privacy failures, and configuration errors, as just a few examples.

KPI GMLC LCS Location 430 tracks the GMLC's ability to retrieve and provide location data for emergency services. This KPI reflects the timeliness and accuracy of location information, which is essential for emergency responders to reach individuals needing help. KPI AMF Service Request (emergency) 435 measures how effectively the AMF processes service requests for emergency sessions. It indicates whether emergency call attempts are being recognized and handled appropriately by the network.

KPI AMF PDU Establishment (emergency) 440 monitors the establishment of packet data units (PDUs) specific to emergency data sessions. A successful PDU establishment is critical for enabling emergency communication services, and failures in this KPI could disrupt emergency data transmission. KPI AMF PDU Session Resource Mod 445 evaluates the modification of resources allocated to an active emergency PDU session, indicating the network's ability to adapt to changes in emergency session requirements. KPI AMF Location Event Notify 450 tracks notifications sent by the AMF related to user location updates during emergency sessions to help maintain accurate real-time location tracking.

KPI AMF Provide Location 455 measures the efficiency and accuracy of the AMF's responses to requests for location information, thereby supporting emergency responders with precise and timely location data. KPI SMF PDU Session SM Create Context (emergency) 460 assesses the SMF's ability to create session contexts for emergency PDU sessions, ensuring proper setup and configuration for emergency service delivery.

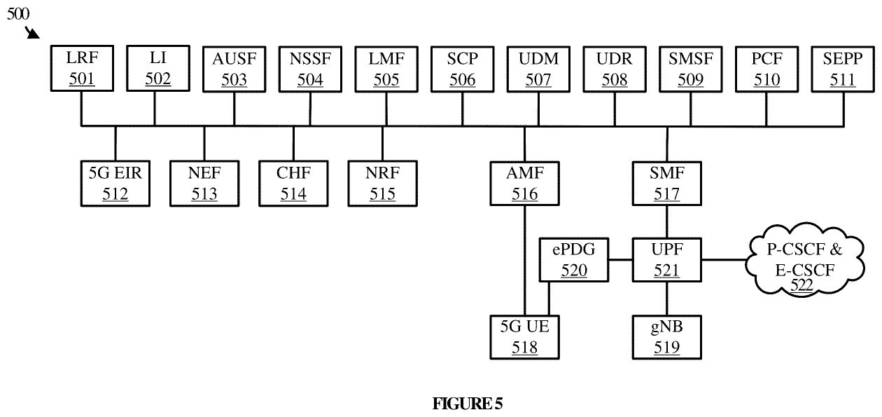

FIG. 5 illustrates 5G network 500. 5G network 500, in some examples, is representative of a 5G standalone communication network as disclosed herein that operates independently of other generations, such as 4G LTE, and uses a dedicated 5G core network. The various operational systems and processes described herein may occur in a 5G standalone network like 5G network 500, in some examples. In other examples, however, the various operational systems and processes described herein may occur in other forms of wireless communication networks including but not limited to non-standalone networks, 4G networks, 3G networks, and the like.

5G network 500 includes packet core network functions (NFs) LRF 501, LI 502, AUSF 503, NSSF 504, LMF 505, SCP 506, UDM 507, UDR 508, SMSF 509, PCF 510, SEPP 511, 5G EIR 512, NEF 513, CHF 514, NRF 515, AMF 516, SMF 517, 5G UE 518, gNB 519, ePDG 520, UPF 521, and P-CSCF/E-CSCF 522. Packet core NFs are network components that control traffic data, provide connectivity, and ensure proper functioning of the network. In other examples, 5G network 500 may include different or additional elements than those illustrated in FIG. 5 including but not limited to a migration function, a provisioning orchestrator, a CRM client, and the like.

LRF 501 is representative of a location retrieval function (LRF) responsible for obtaining and providing accurate location information for user devices, particularly during emergency services. LRF 501 interacts with both the core network and radio access network (RAN) to retrieve location data through various methods such as GPS, cell tower triangulation, or other network-based location techniques. In emergency scenarios, LRF 501 plays a critical role of ensuring that accurate location data is delivered to relevant entities, such as emergency services, in a timely manner to assist in response efforts.

LI 502 is representative of a lawful interception (LI) network function, which enables authorized entities, such as law enforcement agencies, to legally intercept and monitor communications for security and regulatory purposes. LI 502 operates by capturing and securely delivering targeted communication data from the 5G network while ensuring compliance with privacy and legal standards. AUSF 503 is representative of an authentication server function (AUSF) responsible for aspects of user authentication. AUSF 503, in part, generates and validates authentication vectors to ensure that the requesting user equipment (UE) is a legitimate subscriber of 5G network 500. Upon successful authentication, AUSF 503 contributes to establishing a secure communication channel between the UE and the core network by facilitating the generation and distribution of security keys. AUSF 503 may also support network slicing by authenticating access to different network slices based on user subscription. AUSF 503 also supports roaming by interacting with corresponding authentication functions in other networks.

NSSF 504 is representative of a network slice selection function (NSSF). NSSF 504 is responsible for selecting the appropriate network slice for a user device based on the device's subscription data and requested service. This may involve determining which slice or slices are best suited to meet the specific service requirements and the device's subscription profile. NSSF 504 is also responsible for enforcing policies related to network slice access, managing information about the network slices, and interacting with other core network functions to ensure that user equipment is connected to the correct slice and that slice-specific rules are applied.

LMF 505 is representative of a location management function (LMF). LMF 505 is responsible for determining and managing the precise location of user devices, particularly for services that require accurate geolocation data, such as emergency services and location-based applications. LMF 505 works by interacting with the RAN and other core functions to provide real-time location information based on various positioning techniques, including satellite-based and network-based methods. SCP 506 is representative of a session communication proxy (SCP). SCP 506 acts as an intermediary between network functions, optimizing communication by managing and routing signaling traffic. SCP 506 enhances scalability, security, and reliability in the service-based architecture (SBA) by handling load balancing, failure recovery, and policy enforcement across various network functions.

UDM 507 is representative of the unified data management (UDM) entity. UDM 507 is a central entity for managing subscriber data and authentication information. UDM 507 stores and manages subscription-specific information and is responsible for handling the authentication and authorization of users trying to access the network. Although not directly managing sessions, UDM 507 provides necessary information to other network functions, such as AMF 516 and SMF 517, to assist in session establishment and management based on the subscriber's data. UDM 507 also supports seamless service continuity and roaming by managing user identities and security information across different types of networks,

UDR 508 is representative of the unified data repository (UDR). UDR 508 acts as a database (or multiple databases) for storing and managing structured subscriber data and service information. UDR 508 manages access to subscription data for other network functions such as AMF 516, SMF 517, and UDM 507. SMSF 509 is representative of a short message service function (SMSF). SMSF 509 facilitates the delivery and reception of SMS messages over 5G. SMSF 509 manages SMS routing and integration with IP-based services, ensuring that traditional SMS messaging is supported even in the 5G environment without relying on legacy infrastructure. PCF 775 is representative of the policy control function (PCF). PCF 775 is responsible for policy management, which involves creating and enforcing policy rules for network behavior and user data transmission. SEPP 511 is representative of a security edge protection proxy (SEPP). SEPP 511 secures inter-network communications by providing encryption and security enforcement between different service providers. It ensures the confidentiality and integrity of signaling messages exchanged across network borders, protecting data as it traverses between roaming or interconnected networks.

5G EIR 512 is representative of an equipment identity register (EIR). 5G EIR 512 is responsible for managing and validating device identities by checking the International Mobile Equipment Identity (IMEI) against authorized, stolen, or blacklisted devices. It helps prevent unauthorized or compromised devices from accessing the network, enhancing security and protecting network integrity. NEF 513 is representative of a network exposure function (NEF). NEF 513 plays a role in securely exposing the capabilities of core network 705 to external applications and services. NEF 513 may perform functions such as providing standardized APIs for third-party services to access specific network capabilities or information and ensuring that the exposure of network capabilities and user data is managed securely and user privacy is maintained.

CHF 514 is representative of charging function (CHF). CHF 514 is responsible for managing the collection and processing of charging data related to network usage. CHF 514 supports both online and offline charging models, enabling real-time billing and accounting for various services, including data, voice, and messaging, ensuring accurate monetization of network resources. NRF 515 is representative of a network repository function (NRF). NRF 515 acts as a central registry and discovery service for the network functions within the core network. NRF 515 allows other network functions to register their services and discover the services provided by other network functions, maintains up-to-date information on the services offered by different network functions, supports load balancing and fault tolerance mechanisms within the network, and supports the scalability of the network.

AMF 516 is representative of an access and mobility management function (AMF). AMF 516 is responsible for access and mobility management including the initial registration of devices, authentication, tracking area management, and ensuring that users remain connected as they move through the network. AMF 516 serves as the point of contact for a user device when it tries to connect to the 5G standalone network. AMF 516 manages the establishment, maintenance, and termination of the connection between user devices and the core network. AMF 516 may be representative of AMF 135 and/or AMF 415 from the preceding Figures in some examples. SMF 517 is representative of a session management function (SMF). SMF 517 is responsible for session management including establishing, modifying, and releasing sessions (which comprise of one or more data flows). SMF 517 also selects and manages the user plane functions, handles aspects of IP address allocation, and maintains the rules for how data should be routed and reported. SMF 517 ensures that data can be successfully transmitted between user equipment and the internet or other network services. SMF 517 may be representative of SMF 140 and/or SMF 420 from the preceding Figures in some examples.

5G UE 518 is representative of 5G user equipment (UE) using 5G network 500. 5G UE 518 is representative of wireless/wireline user devices. Exemplary user devices include phones, smartphones, computers, vehicles, drones, robots, sensors, and/or other devices with wireless communication capabilities. 5G standalone network exchanges wireless signals with 5G UE 518 over 5G radio frequency bands. gNB 519 is representative of a Next Generation Node B (gNB). gNB 519 is a 5G base station responsible for handling radio communications between user devices and the 5G core network. gNB 519 manages tasks such as radio resource management, mobility control, and data transmission, ensuring efficient and reliable connectivity across the network.

ePDG 520 is representative of an evolved packet data gateway (ePDG). ePDG 520 facilitates secure access to the 5G core for users connected through untrusted non-3GPP networks, such as Wi-Fi. ePDG 520 ensures secure tunneling and encryption of data traffic, enabling seamless mobility and secure communication between the 5G network and external networks. UPF 521 is representative of a user plane function (UPF). UPF 521 is responsible for handling the forwarding and routing of user data packets between devices and external networks, including the internet. UPF 521 helps manage data flow, quality of service (QoS), and enforce traffic policies, ensuring efficient data transmission in applications like streaming, gaming, and even emergency services.

P-CSCF/E-CSCF 522 is representative of a proxy call session control function (P-CSCF) and emergency call session control function (E-CSCF). The E-CSCF is the first point of contact for a device in the IMS architecture, managing SIP signaling for session initiation and routing of multimedia services such as voice and video calls. The E-CSCF ensures secure and efficient communication by forwarding requests to the appropriate IMS entities while enforcing security and QoS policies. The E-CSCF handles emergency calls, determining the appropriate emergency services location and routing emergency call traffic to the correct Public Safety Answering Point (PSAP), ensuring compliance with regulatory requirements for emergency communications.

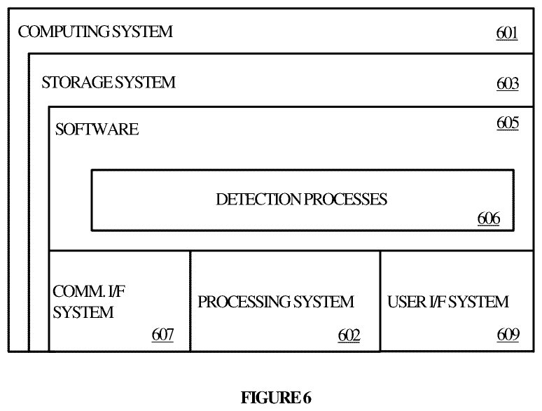

FIG. 6 illustrates computing system 601, which is representative of any system or collection of systems in which the various processes, programs, services, and scenarios disclosed herein may be implemented. Examples of computing system 601 include, but are not limited to, server computers, web servers, cloud computing platforms, and data center equipment, as well as any other type of physical or virtual server machine, container, and any variation or combination thereof. Examples also include desktop and laptop computers, tablet computers, mobile computers, and wearable devices.

Computing system 601 may be implemented as a single apparatus, system, or device or may be implemented in a distributed manner as multiple apparatuses, systems, or devices. Computing system 601 includes, but is not limited to, processing system 602, storage system 603, software 605, communication interface system 607, and user interface system 609 (optional). Processing system 602 is operatively coupled with storage system 603, communication interface system 607, and user interface system 609.

Processing system 602 loads and executes software 605 from storage system 603. Software 605 includes and implements detection processes 606, which is representative of the processes for detecting and identifying nodes causing emergency call failures in a wireless communication network as discussed with respect to the preceding Figures, such as process 200 and process 300. When executed by processing system 602, software 605 directs processing system 602 to operate as described herein for at least the various processes, operational scenarios, and sequences discussed in the foregoing implementations. Computing system 601 may optionally include additional devices, features, or functionality not discussed for purposes of brevity.

Referring still to FIG. 6, processing system 602 may comprise a microprocessor and other circuitry that retrieves and executes software 605 from storage system 603. Processing system 602 may be implemented within a single processing device but may also be distributed across multiple processing devices or sub-systems that cooperate in executing program instructions. Examples of processing system 602 include general purpose central processing units, graphical processing units, application specific processors, and logic devices, as well as any other type of processing device, combinations, or variations thereof.

Storage system 603 may comprise any computer readable storage media readable by processing system 602 and capable of storing software 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 603 may also include computer readable communication media over which at least some of software 605 may be communicated internally or externally. Storage system 603 may be implemented as a single storage device but may also be implemented across multiple storage devices or sub-systems co-located or distributed relative to each other. Storage system 603 may comprise additional elements, such as a controller, capable of communicating with processing system 602 or possibly other systems.

Software 605 (including detection processes 606) may be implemented in program instructions and among other functions may, when executed by processing system 602, direct processing system 602 to operate as described with respect to the various operational scenarios, sequences, and processes illustrated herein. For example, software 605 may include program instructions for implementing the monitoring and identifying network functions causing emergency call failures in a 3G, 4G, and/or 5G wireless communication environment as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software, virtualization software, or other application software. Software 605 may also comprise firmware or some other form of machine-readable processing instructions executable by processing system 602.

In general, software 605 may, when loaded into processing system 602 and executed, transform a suitable apparatus, system, or device (of which computing system 601 is representative) overall from a general-purpose computing system into a special-purpose computing system customized to perform the 4G and 5G network processes described herein. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary, etc.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 607 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

Although the descriptions provided herein may be in the context of certain radio access technologies, networks, and network topologies, such as 5G/NR mobile communications, the proposed concepts, schemes, and any variations thereof may be implemented in, for, and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

As will be appreciated by one skilled in the art, aspects of the present invention may be embodied as a system, method, computer program product, or otherwise. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The wireless data network circuitry described above comprises computer hardware and software that form special-purpose wireless system circuitry to serve wireless user devices based on policies. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose wireless system circuitry to serve wireless user devices based on policies.

Unless the context clearly requires otherwise, throughout the description and the claims, the words “comprise,” “comprising,” “such as,” and “the like” are to be construed in an inclusive sense, as opposed to an exclusive or exhaustive sense, that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents. The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having operations, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method of operating a wireless communication network, the method comprising:
monitoring data associated with one or more emergency call functions to detect abnormalities in the data indicative of emergency call failures;
in response to detecting an abnormality in the data, processing other data associated with one or more other network functions to determine whether one or more corresponding abnormalities are present in the other data; and
in response to determining that at least one corresponding abnormality is present in the other data, generating an alert to indicate that the abnormality exists.

2. The method of claim 1, wherein the data associated with the one or more emergency call functions indicative of the emergency call failures includes at least one of session initiation protocol (SIP) invite data from the one or more emergency call functions and location services data from the one or more emergency call functions.

3. The method of claim 1, wherein the one or more emergency call functions include at least one of a proxy call session control function (P-CSCF) and a gateway mobile location center (GMLC).

4. The method of claim 1, wherein the abnormality in the data corresponds to a timestamp and the corresponding abnormality also corresponds to the timestamp.

5. The method of claim 1, wherein the other data associated with one or more other network functions includes at least one of service request data, packet data unit (PDU) establishment data, session resource modification data, location event notify data, provide location data, and PDU session management create context data.

6. The method of claim 1, wherein the one or more other network functions includes at least one of an access and mobility management function (AMF) and a session management function (SMF).

7. The method of claim 1, wherein:
monitoring the data to detect the abnormalities includes providing the data as input to at least one machine learning model trained to detect the abnormalities; and
processing the other data associated with the one or more other network functions to determine whether the one or more corresponding abnormalities are present in the other data includes providing the other data as input to the at least one machine learning model.

8. The method of claim 7, wherein the at least one machine learning model comprises a kernel density estimation model.

9. One or more non-transitory computer-readable storage media having program instructions stored thereon, wherein the program instructions, when executed by a computing system, direct the computing system to perform operations, the operations comprising:
monitoring data associated with one or more emergency call functions to detect abnormalities in the data indicative of emergency call failures;
in response to detecting an abnormality in the data, processing other data associated with one or more other network functions to determine whether one or more corresponding abnormalities are present in the other data; and
in response to determining that at least one corresponding abnormality is present in the other data, generating an alert to indicate that the abnormality exists.

10. The one or more non-transitory computer-readable storage media of claim 9, wherein the data associated with the one or more emergency call functions indicative of the emergency call failures includes at least one of session initiation protocol (SIP) invite data from the one or more emergency call functions and location services data from the one or more emergency call functions.

11. The one or more non-transitory computer-readable storage media of claim 9, wherein the one or more emergency call functions include at least one of a proxy call session control function (P-CSCF) and a gateway mobile location center (GMLC).

12. The one or more non-transitory computer-readable storage media of claim 9, wherein the abnormality in the data corresponds to a timestamp and the corresponding abnormality also corresponds to the timestamp.

13. The one or more non-transitory computer-readable storage media of claim 9, wherein the other data associated with one or more other network functions includes at least one of service request data, packet data unit (PDU) establishment data, session resource modification data, location event notify data, provide location data, and PDU session management create context data.

14. The one or more non-transitory computer-readable storage media of claim 9, wherein the one or more other network functions includes at least one of an access and mobility management function (AMF) and a session management function (SMF).

15. The one or more non-transitory computer-readable storage media of claim 9, wherein:
monitoring the data to detect the abnormalities includes providing the data as input to at least one machine learning model trained to detect the abnormalities; and
processing the other data associated with the one or more other network functions to determine whether the one or more corresponding abnormalities are present in the other data includes providing the other data as input to the at least one machine learning model.

16. The one or more non-transitory computer-readable storage media of claim 15, wherein the at least one machine learning model comprises a kernel density estimation model.

17. A system comprising:
one or more computer-readable storage media;
a processing system operatively coupled with the one or more computer-readable storage media; and
program instructions stored on the one or more computer-readable storage media, wherein the program instructions, when read and executed by the processing system, direct the processing system to at least:
monitor data associated with one or more emergency call functions to detect abnormalities in the data indicative of emergency call failures;
in response to detecting an abnormality in the data, process other data associated with one or more other network functions to determine whether one or more corresponding abnormalities are present in the other data; and
in response to determining that at least one corresponding abnormality is present in the other data, generate an alert to indicate that the abnormality exists.

18. The system of claim 17, wherein the data associated with the one or more emergency call functions indicative of the emergency call failures includes at least one of session initiation protocol (SIP) invite data from the one or more emergency call functions and location services data from the one or more emergency call functions.

19. The system of claim 17, wherein the one or more emergency call functions include at least one of a proxy call session control function (P-CSCF) and a gateway mobile location center (GMLC).

20. The system of claim 17, wherein the abnormality in the data corresponds to a timestamp and the corresponding abnormality also corresponds to the timestamp.
